(19) United States
(12) Patent Application Publication
(10) Pub. No.: US 2025/0184819 A1
(43) Pub. Date: Jun. 5, 2025

(54) FACILITATING ENERGY AWARE ADMISSION CONTROL WITH DYNAMIC LOAD BALANCING IN ADVANCED COMMUNICATION NETWORKS

(71) Applicant: Dell Products, L.P., Round Rock, TX (US)

(72) Inventors: Umair Sajid Hashmi, Mississauga (CA); Jeebak Mitra, Ottawa (CA); Gwenael Poitau, Montreal (CA)

(21) Appl. No.: 18/524,736

(22) Filed: Nov. 30, 2023

(51) Int. Cl. H04W 28/082; H04W 28/086

(52) U.S. Cl. CPC H04W 28/082; H04W 28/086

(57) ABSTRACT

Facilitating energy aware multi-cell admission control with dynamic load balancing in advanced communication networks is provided herein. A method includes facilitating, by a system comprising a processor, energy efficiency aware load balancing of already served user equipment. The method also includes facilitating, by the system, controlling of admissions of other user equipment to the communication network. The communication network can be deployed as a disaggregated architecture that comprises central units, distributed units, and a near-real-time-radio access network intelligent controller. The group of cells can be configured to operate according to a new radio network communication protocol.

### BACKGROUND

The use of computing devices is ubiquitous. Given the explosive demand placed upon mobility networks and the advent of advanced use cases (e.g., streaming, gaming, and so on), power consumption in such networks is higher as compared to Long Term Evolution (LTE) networks, for example. Such power consumption can be attributed to the exponential increase in the network traffic flowing through the advanced network and the need for faster processing of complex tasks. Accordingly, unique challenges exist related to network efficiency and in view of forthcoming Fifth Generation (5G), new radio (NR), Sixth Generation (6G), or other next generation, standards for network communication.

The above-described context with respect to communication networks is merely intended to provide an overview of current technology and is not intended to be exhaustive. Other contextual descriptions, and corresponding benefits of some of the various non-limiting embodiments described herein, will become further apparent upon review of the following detailed description.

### SUMMARY

The following presents a simplified summary of the disclosed subject matter to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An embodiment relates to a method that includes facilitating, by a system comprising a processor, energy efficiency aware load balancing of already served user equipment. The energy efficiency aware load balancing distributes the already served user equipment among a group of cells of a communication network. The method also include facilitating, by the system, controlling of admissions of other user equipment to the communication network. Facilitating the energy efficiency aware load balancing and the facilitating the controlling of the admissions can include evaluating feedback data representative of near-real-time quality of service performance indicator feedback and based on the feedback data, controlling the energy efficiency aware load balancing and the admission control. The controlling can result in a mitigated degradation of a quality of service of the already served user equipment. The communication network can be deployed as a disaggregated architecture that comprises central units, distributed units, and a near-real-time-radio access network intelligent controller. The group of cells can be configured to operate according to a new radio network communication protocol.

Facilitating the energy efficiency aware load balancing can include selecting a first cell of the group of cells for offloading of a first user equipment of the already served user equipment to a second cell of the group of cells. The group of cells is within control of a near-real-time-radio access network intelligent controller. In addition, facilitating the energy efficiency aware load balancing can include, based on selection of the first cell, providing information indicative of offload instructions for the first user equipment to a centralized unit for validation.

The above implementations can include, based on a completion of the connection transfer of the user equipment, determining, by the system, an outcome of the connection transfer as a function of a change in a network utility. Further, the system can communicate the change in the network utility for incorporation into a reinforcement learning model.

In an implementation, the controlling resulting in the mitigated degradation of the quality of service of the already served user equipment can include the controlling resulting in minimized degradation of the quality of service of the already served user equipment. Facilitating the controlling of the admissions of other user equipment can include based on receipt of a connection request from a first user equipment of the other user equipment, activating an admission control procedure. In addition, based on a result of the admission control procedure and based on acceptance of an admission policy and a utility function, the method can include selectively admitting the first user equipment to the group of cells. In some implementations, based on completion of an admission of the first user equipment, the method can include communicating, by the system, cell level data for incorporation into a reinforcement learning model.

Another embodiment relates to a system that includes a processor and a memory that stores executable instructions that, when executed by the processor, facilitate performance of operations. The operations can include, based on activation of a load balancing procedure, selecting a first cell of cells for offloading of a first user equipment to a second cell of the cells. The cells are within control of a near-real-time-radio access network intelligent controller. Further, the load balancing procedure can include, based on selection of the first cell, providing information indicative of offload instructions for the first user equipment to a centralized unit for validation. The operations can also include, based on receipt of a connection request from a second user equipment, activating an admission control procedure. Further, based on a result of the admission control procedure, selectively admitting the second user equipment to the cells based on acceptance of an admission policy and a utility function. In an example, the load balancing procedure is activated based on a cell within a cluster being determined to satisfy a utilization threshold. The system can be deployed in a disaggregated architecture of network equipment.

Further to the above implementations, the operations can include, based on a completion of the connection transfer of the second user equipment, determining an outcome of the connection transfer as a function of a change in a network utility. The operations can also include, communicating the change in the network utility to a reinforcement learning model. In some implementations, the operations can also include, based on the validation of the offload instructions by the centralized unit, transferring the offload instructions to a scheduler for initiation of a connection transfer of the first user equipment.

According to some implementations, the operations can include, prior to the selecting of the first cell, obtaining average data usage from the cells, wherein the selecting is based on the average data usage and a defined policy. In an example, the defined policy is based on a function of cell loads, Physical Resource Block (PRB) utilization, and load states of neighbor cells.

In accordance with some implementations, activating the admission control procedure can include recommending, to a control unit (CU), a policy for admission of the second user equipment. Based on acceptance of the policy by the CU and based on a determination that the second user equipment is to be admitted in a same radio unit (RU) that received the connection request from the second user equipment, an acceptance acknowledgment can be sent to the second user equipment. In addition, activating the admission control procedure can include completing setup of the second user equipment with a selected cell of the cells.

In some implementations, activating the admission control procedure can include recommending, to a control unit (CU), a policy for admission of the second user equipment. based on acceptance of the policy by the CU and based on a determination that the second user equipment is to be admitted in a different cell than the cell that received the connection request from the second user equipment, sending redirect information to the second user equipment. In addition, activating the admission control procedure can include completing setup of the second user equipment with the different cell. According to some implementations, the operations can include, based on completion of the admission of the second user equipment at the different cell, communicating cell level data to a reinforcement learning model.

Yet another embodiment relates to a non-transitory machine-readable medium, comprising executable instructions that, when executed by a processor of network equipment, facilitate performance of operations. The operations can include performing, by a system comprising a processor, energy efficiency aware load balancing with respect to already served user equipment. The energy efficiency aware load balancing distributes the already served user equipment among a plurality of cells of a communication network. The operations can also include controlling, by the system, admissions of other user equipment to the communication network. The energy efficiency aware load balancing and the controlling of the admissions can include evaluating near-real-time quality of service performance indicator feedback. Based on the near-real-time quality of service performance indicator feedback, the operations can include controlling the energy efficiency aware load balancing and the admissions to result in a reduced degradation of a quality of service of the already served user equipment.

In an implementation, the energy efficiency aware load balancing can include selecting a first cell of the plurality of cells to use to offload a first user equipment of the already served user equipment to a second cell of the plurality of cells. The plurality of cells is within control of a near-real-time-radio access network intelligent controller. The energy efficiency aware load balancing can also include, based on selection of the first cell, providing information indicative of offload instructions for the first user equipment to a centralized unit for validation.

In some implementations, the controlling of the admissions of other user equipment can include, based on receipt of a connection request from a first user equipment of the other user equipment, activating an admission control procedure. Based on a result of the admission control procedure, selectively admitting the first user equipment to the plurality of cells based on acceptance of an admission policy and a utility function.

To the accomplishment of the foregoing and related ends, the disclosed subject matter includes one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description can include additional or alternative embodiments beyond those described in this summary.

### BRIEF DESCRIPTION OF THE DRAWINGS

Various non-limiting embodiments are further described with reference to the accompanying drawings in which:

FIG. 1 illustrates an example, non-limiting, system architecture for multi-cell user equipment admission control in accordance with one or more embodiments described herein;

FIG. 2 illustrates a first equation (1) for an optimization objective in accordance with one or more embodiments described herein;

FIG. 3 illustrates a second equation (2) for a power consumption factor in accordance with one or more embodiments described herein;

FIG. 4 illustrates a third equation (3) for mathematically expressing the different urgencies or priorities for network service in accordance with one or more embodiments described herein;

FIG. 5 illustrates an example, non-limiting table of the RRC rejection rate variation based on parameter changes in accordance with one or more embodiments described herein;

FIG. 6 illustrates a flow diagram of an example, non-limiting, computer-implemented method that facilitates load balancing for multi-cell user admission control in accordance with one or more embodiments described herein;

FIG. 7 illustrates a flow diagram of an example, non-limiting, computer-implemented method that facilitates multi-cell user admission control in accordance with one or more embodiments described herein;

FIG. 8A illustrates a fourth equation (4) for a long-term reward function in accordance with one or more embodiments described herein;

FIG. 8B illustrates a fifth equation (5) for the long-term reward function in accordance with one or more embodiments described herein;

FIG. 9 illustrates a flow diagram of an example, non-limiting, computer-implemented method that facilitates dynamic load balancing in advanced communication networks in accordance with one or more embodiments described herein;

FIG. 10 illustrates a flow diagram of an example, non-limiting, computer-implemented method that facilitates energy aware admission control in advanced communication networks in accordance with one or more embodiments described herein;

FIG. 11 illustrates an example, non-limiting, computing environment in which one or more embodiments described herein can be facilitated; and

FIG. 12 illustrates an example, non-limiting, networking environment in which one or more embodiments described herein can be facilitated.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details. In other instances, well-known structures and devices are shown in block diagram form in order to facilitate describing the various embodiments.

The high energy consumption of mobile networks (e.g., 5G networks and other advanced networks) is a source of concern for various reasons. For example, the high energy consumption can increase the operators' operational expenditure (OPEX). In another example, the high energy consumption can increase atmospheric emissions, which can be in direct conflict with strategic climate goals and/or policies adopted by governments and corporations around the globe. Conventional static energy saving techniques are not effective in mobile networks that have varying traffic loads and user equipment mobility patterns. Multiple energy saving (ES) features, such as deep sleep mode, carrier shut down, and radio frequency (RF) channels' switch off can be available in conventional cellular networks (e.g., 5G networks and other advanced networks). However, due to the large parameter space involved in determining energy consumption, the ensuing optimization problem becomes non-polynomial-hard (NP-hard), which utilizes significant computation for yielding optimal values for such parameters.

Recently, ES on shorter time scales have been proposed in academia as well as industry standards. These proposals include at symbol-level, subframe-level, and/or frame-level advanced sleep modes (ASM). The challenge for network operators, as well as standardization bodies, is to streamline network operational processes for energy efficiency (EE) specific use cases, such as activation and/or deactivation of sleep mode functionality and site energy management.

To overcome the above as well as related issues, the data driven approaches discussed herein can outperform classical optimization techniques in terms of performance and real-time inferences. Provided are techniques for leveraging artificial intelligence (AI) and/or machine learning (ML) for EE with negligible impact on the user Quality of Experience (QoE), which, until now, has been an unexplored field of knowledge as it relates to communication networks.

In this regard for the avoidance of doubt, any embodiments described herein in the context of optimizing performance are not so limited and should be considered also to cover any techniques that implement underlying aspects or parts of the described aspects to improve or increase performance, even if resulting in a sub-optimal variant obtained by relaxing aspects or parts of a given implementation or embodiment.

A concern for future networks (5G, 6G, NR, and beyond) is catering to a higher number of user equipment (UEs) while meeting the diverse quality of service (QoS) demands of the UEs. To this and related ends, provided herein is a multi-cell framework for dynamic load balancing between a cluster of cells while minimizing network energy consumption while ensuring high QoS to the UEs. The disclosed embodiments leverage reinforcement learning and other AI techniques (e.g., transfer learning, federated learning, and/or intent based learning).

Although 5G networks can have some inherent enhanced efficiency as compared to previous generations of cellular networks, the power consumption for 5G (and other advanced) networks is higher than the power consumption for other networks, such as Long Term Evolution (LTE) networks. The higher power consumption in 5G networks is due to the exponential increase in the traffic flowing through the network and the need for faster processing of complex tasks to facilitate the high target data rates. Network sustainability through increased energy savings is, thus, an important design requirement for current and future networks.

Without any control on the number of UEs admitted to a cell, the QoS experienced at the UEs can deteriorate as the number of UEs served by a cell can saturate the capacity of the cell. However, since the magnitude and diversity of devices (e.g., UEs) is ever increasing, simply setting a fixed threshold to limit the maximum number of devices served by a cell is inefficient. There are some measures that have already been considered in network operation. One measure has been a process and criteria for setting the maximum number of UEs that can use a network slice (NS) simultaneously as part of NS admission control (AC). Another measure is that operators may set counters at the Radio Resource Control (RRC) level to control the maximum number of UEs in a cell.

Recently some data-driven solutions based on a dynamic threshold have emerged. However, their decisions are applied per single cell and may lead to denial-of-service for rejected UEs and/or network load imbalances. Accordingly, the disclosed embodiments provide a solution to the problem of network wide user admission control with the target of maximizing the network wide served users in an energy efficient manner while satisfying user QoS constraints.

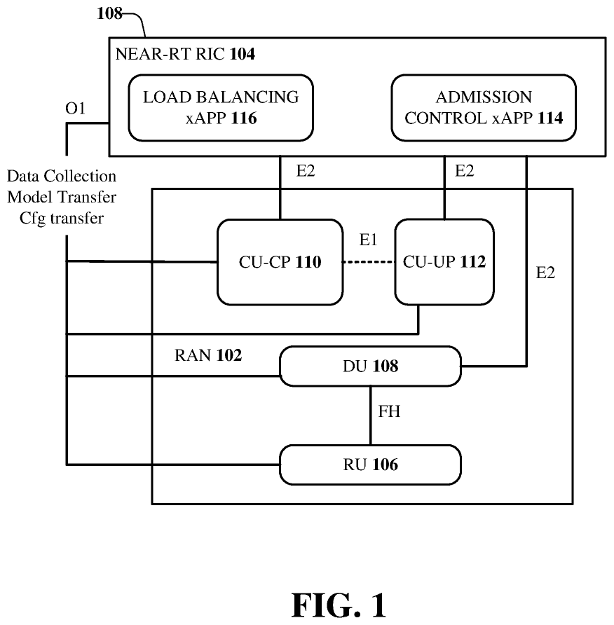

FIG. 1 illustrates an example, non-limiting, system architecture 100 for multi-cell user equipment admission control in accordance with one or more embodiments described herein. As mentioned, the disclosed embodiments, including the admission control, can be within various types of disaggregated architecture.

It is noted that for purposes of explanation, an O-RAN framework will be discussed. However, the disclosed embodiments are not limited to an O-RAN framework implementation and, instead, other types of disaggregated architecture can be utilized with the various embodiments discussed herein. Further, as it relates to the O-RAN framework, the network equipment can include, but is not limited to, O-RAN Radio Units (O-RUs) and Random Access Network Intelligent Controllers (RICs). Further, the network automation tools include, but are not limited to, an rApp and an xApp.

The disclosed embodiments provide technical solutions to several technical problems. For example, the disclosed embodiments can simultaneously achieve load balancing and energy efficiency. Provided herein are methods and other embodiments for load balancing a cluster of cells within a network, targeting a maximization of a utility function, which, for a given number of UEs maximizes the energy efficiency of the network while ensuring that QoS constraints are met for a diverse class of UEs.

In another example, the disclosed embodiments provide a near real-time online learning based approach. Conventional load balancing approaches fail to gain insights from the prevailing traffic conditions of the network and combine them with a predicted traffic load to optimally budget for capacity within the network. Such approaches typically tend to have pre-defined thresholds that are used as triggers for initiating user migration when capacity hotspots are created. Even when such triggers try to re-optimize the network state, an aggregate energy consumption criterion is seldom considered. Therefore, the disclosed embodiments provide approaches that can be applied to provide near real-time policies for load balancing in an energy efficient manner within an optimization framework that holistically accounts for both.

In yet another example, the disclosed embodiments overcome the problem associated with the lack of standardized implementation in disaggregated architectures. With the growing adoption of disaggregated network architectures (such as Open Radio Access Networks (O-RAN) based network equipment) development for enablement of AI and/or ML based network optimization, an appropriate message and control flow amongst the various entities also needs to be established. From an implementation perspective, therefore, clear definition of the data and control flow between the elements of the O-RAN nodes is also needed. Data for the purposes of the disclosed embodiment may include statistical information and network key performance indicators (KPIs) from O-RAN radio unit (O-RU) and O-RAN data unit (O-DU) to the RAN intelligent controllers (RICs), model training, model deployment and the messages that are to be exchanged for user admission control and traffic steering configurations from the applications deployed on the RIC platform.

As discussed herein, provided is a data-driven solution that improves the UE admission performance of the network while concurrently balancing the network load dynamically and reducing its energy consumption. The subject disclosure outlines the use of AI and/or ML techniques within the framework that is an energy efficient method for UE admission and load balancing (LB) while minimizing the QoS violations. The disclosed embodiments are based on two running (e.g., executing) applications: one for admission control and the other for dynamic load balancing within the network. The two running application can be applications that are executing simultaneously, at a same time, at substantially the same time, concurrently, consecutively, or at different times. The main objective for both applications is to serve a maximum number of UEs requesting service within a given set of QoS constraints defined for each class of traffic. For a cluster of Radio Units (RU) cells managed by a common central coordinating and/or controlling entity (such as RAN intelligent controller), the optimization is performed for a longer time frame (e.g., 10 time slots) than real-time algorithms (e.g., L2 scheduling) and for the entire cell space.

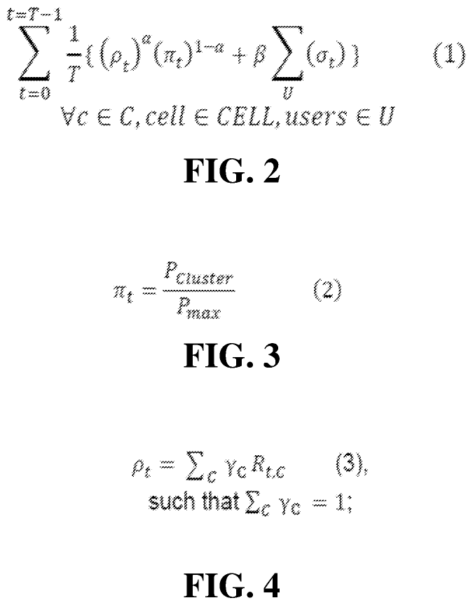

FIG. 2 illustrates a first equation (1) for an optimization objective in accordance with one or more embodiments described herein. In the first equation (1), ρₜ is the RRC rejection ratio and πₜ is the power consumption factor subject to a combination of four constraints as follows:
Constraint 1: β>α≤1,
Constraint 2: SINR_{c}>SINR_{thresh,c},
Constraint 3: Delay_{c}<Delay_{thresh,c},
Constraint 4: PRButil_{cell}<PRButilₜₕᵣₑₛₕ

The RRC rejection ratio (ρₜ) is the percentage of UEs not admitted in the network after receipt of a connection request from those UEs. Additionally, the power consumption factor (πt) is the ratio of power consumed by the network during a time instance and the maximum (max) power consumption at highest load and without any power saving measure and given by a second equation (2), which is depicted in FIG. 3.

In the second equation (2), P_{Cluster} is the average power consumption over T slots. Pₘₐₓ is the maximum power consumption of the cluster corresponding to when the cells operate at full load. Similarly, the UE migration ratio σₜ denotes the percentage of UEs which have to be shifted to neighboring cells as part of the optimization process. C is the set of device classes in the network. The device classes can be related to different 5G use cases, such as enhanced mobile broadband (eMBB) devices for high data volume and throughput needs, ultra-reliable low latency communication (URLLC) devices for access delay or latency sensitive devices, and massive machine type communication (mMTC) for internet of things (IoT) and/or internet of everything (IoE) based device types.

Further, CELL and U are the sets containing all the cells and UEs within the cluster, respectively. Further, α is the tradeoff parameter between RRC rejection rate and the network power consumption, while β is the penalty weighting constant within the utility function to account for the control and signaling overhead caused by UE handovers within the load balancing mechanism. To avoid frequent and unnecessary handovers, β can be retained at a higher value than the α.

The applications target to maximize the number of served UEs over an interval of T slots while ensuring that the mean (in some embodiments it may also be some percentile) of the UE signal-to-interference-and-noise ratio (SINR) over T slots remains above a set threshold for that class of UEs. The service delay, which is important for ultra-reliable low latency communications (URLLC) based UEs, can also be used as an optimization constraint. PRButilcell denotes the physical resource block (PRB) utilization of a cell from the set CELL which contains all the cell sites in the network. The constraint signifies that the PRB utilization of all cells at all time slots should not exceed the maximum PRB utilization limit given by PRButilₜₕᵣₑₛₕ. The policy aims to recommend actions to achieve these goals in an energy efficient manner, through its explicit inclusion within the utility function. Depending on the value of a, the applications recommend policies that establish a Pareto-optimal tradeoff between the RRC rejections and the power consumption of the cell cluster.

Different classes of UE devices may have different urgencies or priorities for network service. For example, a UE class with real-time requirements will have a more urgent need for resources as compared to other classes (or UEs) with non-real time constrained delay. This is captured in the first equation (1) in FIG. 2 in the elaboration of the RRC rejection rate, where rejecting a UE with a high priority class may generate a higher penalty than rejecting a UE from a non-priority class. Mathematically, this may be given as third equation (3), as illustrated in FIG. 4.

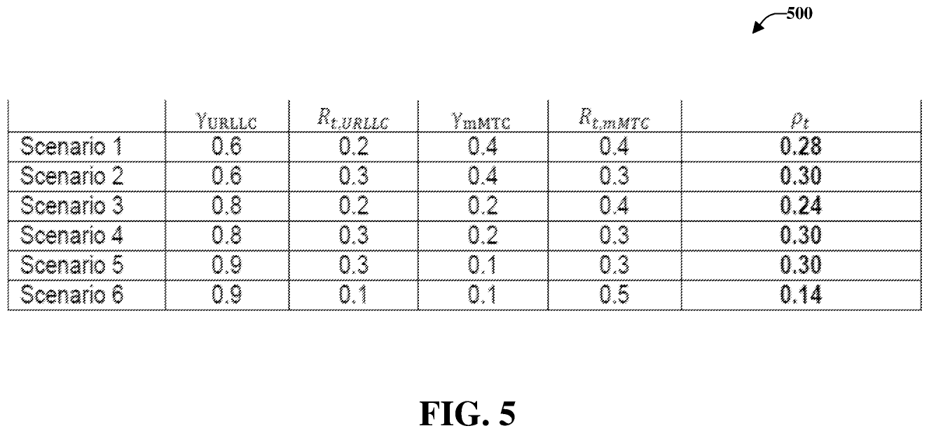

In the third equation (3), γC is the priority weight of class ‘C’, and Rt,C is the rejection rate of class ‘C’ UEs in time slot ‘t’. As an example, URLLC devices which have a stringent service requirement may have a higher priority factor as compared to mMTC class devices. As an example, FIG. 5 illustrates an example, non-limiting, table 500 of the RRC rejection rate variation based on parameter changes in accordance with one or more embodiments described herein. The table 500 uses a combination of scenarios to show the sensitivity of the RRC rejection rate value to class with the higher priority weightage.

For example, the table 500 shows different classes of devices, such as URLLC devices, mMTC devices, and so on. Each scenario (scenario 1 through scenario 6) is provided to provide examples of how the RRC rejection ratio (ρt) might be affected.

The disclosed embodiments provide automatic dynamic load balancing and admission control through a novel utility function. Current industry standards already have elements of load balancing, power control, and user admission control that typically use a threshold-based criteria. However, these thresholds are static in nature, and hence are unable to adapt to real-time traffic variations and QoS violations. The disclosed embodiments provide a data-driven framework with a dynamic policy for joint power consumption, user admission control, and automatic load balancing while ensuring user QoS satisfaction. For this purpose, the formulated utility function is a combination of total cluster power consumption, RRC rejection ratio, and handover penalty triggered by the load balancing.

Further, the disclosed embodiments provide a data driven framework for jointly optimal admission control for energy efficiency and load balancing. In the data-driven approach as provided herein, performance optimization is performed for a cluster of cells in the network. Since the formulation leads to a multi-objective optimization problem at the cell level, there is a complex relationship of the parameter set that is further compounded by the fact that the objectives may lead to a conflicting set of actions when addressed independently. Due to the need for joint optimization, a mechanism is defined whereby the central controller may suggest from multiple policies on UE load balancing between cells, and RRC request forwarding for improving PRB utilization, network energy efficiency, while maintaining overall user UE QoS.

Since the environment where the optimization is being performed can have a highly dynamic nature, the use of a reinforcement learning (RL) based model that receives network telemetry data from RU and DU nodes, provides user AC recommendation when a new UE admission request is received, and load balancing suggestions at pre-specified time intervals (or through network-event based trigger); and updates its actions based on the reward received from the environment is utilized. The RL agent perceives and interprets the environment, takes actions and learns by trial and error to achieve the best outcomes as per the optimization objective. The optimization function per cell cluster is a combination of RRC rejection rate, cluster wide cell power consumption, and handover costs; constrained by QoS satisfaction rate for each device class of UEs. Note that the QoS criteria is device class dependent, implying each device class would have a unique set of KPIs and/or threshold to determine the percentage of devices having satisfactory QoS performance. The different cells within the cluster should cooperate to maximize the cumulative reward of the cluster.

With reference again to FIG. 1, provided are a RAN 102 and a near-RT-RIC 104. As noted, although discussed with respect to O-RAN as the deployment architecture for purposes of describing the disclosed embodiments, similar mechanisms would be applicable within other versions of disaggregated network architectures.

In an O-RAN based disaggregated architecture, a network model in FIG. 1 assumes one or more RUs 106 connected with a unique RAN Data Unit (DU 108) and RAN Control Unit (CU), illustrated as a CU control plane (CU-CP 110) and a CU-user plane (CU-UP 112). The DUs 108 and CUs are connected to a regional cloud that includes the near-RT-RIC 104. Although not illustrated, a scheduler can be included in the DU 108.

While a one-to-one relationship between the CU (e.g., the CU-CP 110 and the CU-UP 112) and near real-time RIC (near-RT-RIC 104) has been depicted in the architecture of FIG. 1, it is noted that the framework is also applicable when a single near-RT RIC is deployed to optimize network operations across multiple CUs, so that multiple cells can be managed by xApps (a software application within the near-RT-RIC to implement specific functions or services in near-real-time) hosted by the near-RT-RIC. The near-RT-RIC 104 supports admission control xApp 114, which is responsible for coordinated UE admission and QoS control of multiple cells within its footprint. The near-RT-RIC 104 also supports and a load balancing xApp 116, which is responsible for load balancing the UE admissions. Further the near-RT-RIC 104 can improve the performance of multiple cells within its footprint.

The xApps (e.g., the admission control xApp 114, the load balancing xApp 116) are based on an RL approach, such as deep deterministic policy gradient (DDPG) algorithm which is a model-free, online, off-policy reinforcement learning method. A DDPG agent is an actor-critic (AC) RL agent that searches for an optimal policy that maximizes the expected cumulative long-term reward. Actor-critic (AC) agents can implement actor-critic procedures. For example, the actor-critic procedures can include model-free on-policy reinforcement learning methods. The actor-critic agent can optimizes the policy (actor) directly and can use a critic to estimate the expected discounted cumulative long-term reward. The DDPG agent utilizes history of the past actions and rewards. In various embodiments provided herein, action space pruning techniques can be applied to reduce the action space both in AC and LB xApps.

In some embodiments, the model training can be performed offline and/or on a digital twin to avoid disruption in a functioning network. Once the models for LB and AC use cases are trained, inference models for cell level coordination are deployed in the near-RT-RIC as xApps. The RL model update can continue based on new data to capture the changes in the operating environment. However, to save on the computational cost of continual training other mechanisms such as model performance thresholds can be used to trigger model retraining. For example, retraining can occur if it is determined that the performance falls below a set threshold. The objective of both the xApps is optimization of the problem under constraints outlined in the first equation (1) of FIG. 2. The description of the xApps will now be provided.

It should be noted that terms such as “real-time,” “near real-time,” “dynamically,” “instantaneous,” “continuously,” and the like can refer to data which is collected and processed at an order without perceivable delay for a given context, the timeliness of data or information that has been delayed only by the time required for electronic communication, actual or near actual time during which a process or event occur, and temporally present conditions as measured by real-time software, real-time systems, and/or high-performance computing systems. Real-time software and/or performance can be employed via synchronous or non-synchronous programming languages, real-time operating systems, and real-time networks, each of which provide frameworks on which to build a real-time software application. A real-time system may be one where its application can be considered (within context) to be a main priority. In a real-time process, the analyzed (input) and generated (output) samples can be processed (or generated) continuously at the same time (or near the same time) it takes to input and output the same set of samples independent of any processing delay.

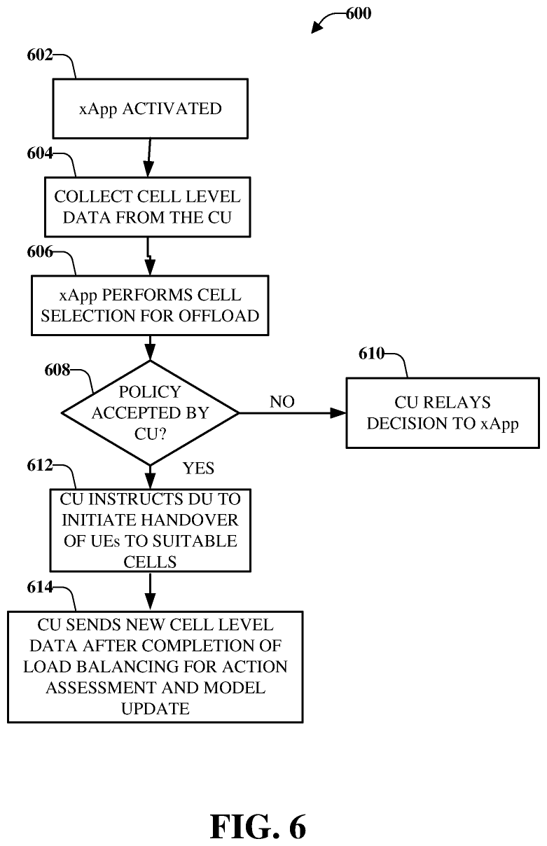

FIG. 6 illustrates a flow diagram of an example, non-limiting, computer-implemented method 600 that facilitates load balancing for multi-cell user admission control in accordance with one or more embodiments described herein. The computer-implemented method 600 and/or other methods discussed herein can be implemented by a system comprising a processor and a memory. In an example, the system can be implemented by a network equipment of a disaggregated network architecture. It is noted that the embodiment of FIG. 6 is discussed with respect to being deployed within an O-RAN framework, however, the disclosed embodiments are not limited to an O-RAN framework.

The load balancing of FIG. 6 can be facilitated via a Load Balancing xApp in accordance with one or more embodiments. At 602, the Load Balancing (LB) xApp is triggered (or activated). The application can be triggered after a set time interval and/or when one of the cells within the cluster reaches a utilization threshold. At 604, cell level data is collected from the CU. Average data usage from the cells can be determined. Based on the average data usage from the cells within the near-RT-RIC control, the xApp decides, at 606, whether UEs from a certain cell need to be offloaded to other candidate cells. At any decision instance, the xApp will select, at most, a single cell for UE offloading, to avoid drastic change in network loads. Dynamic load balancing policies are a function of cell loads, PRB utilization and the load states of neighbor cells.

Upon or after a cell is selected, at 606, for load balancing, the CU is notified of the policy. At 608 a determination is made whether the CU accepts the policy. If the policy is not accepted (“NO”), the decision is communicated to the xApp, at 610.

Alternatively, if the CU accepts the policy at 608 (“YES”), the CU can validate and transfer the instructions to a MAC scheduler for initiating the connection transfer from source to target cells. For example, at 612, the CU informs (or instructs) the CU to initiate handover of UEs to suitable cells. The quantity of UEs that should be offloaded depends on policies for Radio resource and mobility management layer, also known as Layer 3 (L3) and can be a function of UE QoS, the UE Reference Signal Received Power (RSRP), and UE SINR values.

Upon or after the UE migration is completed, the outcome (or reward), which is a function of the change in network utility as a result of the action, is fed back to the xApp for refinement and improvement of future policy recommendations. For example, at 614, the CU sends new cell level data upon or after load balancing is complete for action assessment and model update.

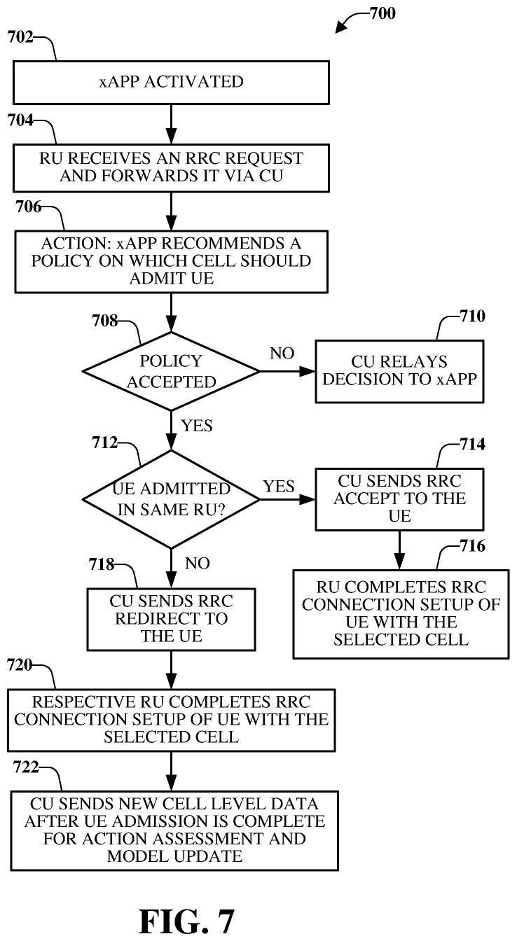

FIG. 7 illustrates a flow diagram of an example, non-limiting, computer-implemented method 700 that facilitates multi-cell user admission control in accordance with one or more embodiments described herein. The computer-implemented method 700 and/or other methods discussed herein can be implemented by a system comprising a processor and a memory. In an example, the system can be implemented by a network equipment of a disaggregated network architecture. It is noted that the embodiment of FIG. 7 is discussed with respect to being deployed within an O-RAN framework, however, the disclosed embodiments are not limited to an O-RAN framework.

The admission control of FIG. 7 can be facilitated via an Admission Control (AC) xApp in accordance with one or more embodiments. The admission control xApp is an application (in addition to the load balancing xApp) in the model. The admission control xApp operates as a gate keeper to the number of UEs within the network.

At 702, the xApp is triggered (or activated), which can be based on receipt of an RRC request at the RU. At 704, upon or after the RU receives the RRC request, the RU forwards the RRC request via the CU. If the cluster of cells under near-RT-RIC is determined to be already in a congested state, the AC xApp may reject the RRC request from the UE. However, with consecutive rejections, the RRC rejection ratio increases, which consequently decreases the cluster utility. This application (e.g., the admission control xApp) is triggered when an O-RU receives an RRC request.

Instead of RRC directly taking the decision on admitting the UE to a cell, the RRC utilizes feedback from the xApp, which uses cell level data on cell load, power consumption, UE device class distribution, QoS values per device class, neighbor cell load, and so on, to decide the cell where the UE should be connected to (in the situation where it is admitted in the network). Accordingly, at 706, the xApp recommends a policy on which cell should admit the UE.

At 708, a determination is made whether the CU accepts the policy. If not accepted (“NO”), the CU communications the rejection decision to the xApp, at 710. For example, in the situation where the xApp determines that admitting the UE to any of the available cells will lower the utility, it sends an RRC reject recommendation to the O-CU.

Alternatively, if the policy is accepted at 708 (“YES”), a determination is made, at 712, whether the UE is recommended to be admitted in the same RU that received the RRC request. In the situation where the policy recommends admission of the UE in a cell of the same O-RU which received the RRC request (e.g., the determination at 712 is “YES”), at 714, the O-CU sends the RRC accept back to the UE. Thereafter, at 716, the RRC Connection Setup takes place. For example, the RU completes the RRC connection setup of the UE with the selected cell.

Alternatively, if the determination at 712 is that the xApp suggests admitting the UE in a cell of a different O-RU (“NO”), at 718, the RRCRedirectInfo is sent to the UE. For example, the RRC redirect information can be sent to the UE upon or after the policy is approved by the CU. At 720, the respective RU completes the RRC connection setup process with the new cell as identified (or selected) by the xApp. Upon or after the UE admission is complete, at 722, the CU sends new cell level data for action assessment and model update.

In accordance with some embodiments, provided herein is an RL based learning mechanism for jointly operating the AC and LB applications (e.g., the admission control xApp and the load balancing xApp). This embodiment includes the RL based process, which will be discussed in further detail below. The novelty within this embodiment lies in how the elements of the state space are used to define the actions pertaining to AC and LB applications, and the reward function which is shaped exponentially to ensure faster convergence. The process can be any RL based process, such as the deep Q network (DQN), or any other variant like DDPG, with the following details.

State Space: The state space for the RL learning model can contain various features from the cell cluster, some of these features are noted below, as a non-exhaustive list per cell.
Cell Loads (number of UEs connected)
PRB Utilization
RSRPxth percentile
SINRxth percentile
Delayxth percentile
RRC rejection ratio
N1 Cell Load
N1 RSRPxth percentile
N1 SINRxth percentile
N1 Delayxth percentile
N2 Cell Load
N2 RSRPxth percentile
N2 SINRxth percentile
N2 Delayxth percentile

The cell load, RSRP, SINR, and delay values for the two closest neighbor cells (N1—closest and N2—2nd closest) will be received by the near-RT RIC in a longer time scale. Although the neighbor cell statistics may not be updated in real-time, the past values are still expected to help with the learning as the agent will make decisions based on the load and KPI comparison between itself and the neighbor cells. Finally, instead of using the commonly used mean statistics, the disclosed embodiments use the xth percentile values, where ‘x’ determines how much satisfaction is being targeted. For example, a 5th or a 10th percentile stat would mean the embodiments are ensuring that at least 95% or 90% of users experience performance that is satisfactory in terms of QoS.

Action Space: The action space for the AC application (e.g., the access control xApp) would either be ACCEPT along with the Cell ID of the cell where the application forwards the RRC request to (in case it is not the cell which receives the RRC request); or a REJECT in case the application deems adding the UE in any cell within the cluster would be detrimental to the utility function. Considering that there are N cells within a cluster, the action space for this application (e.g., the AC application) is N+1. The action space for the LB application (e.g., the load balancing xApp) upon triggering is the selection of the cell which should offload some UEs to improve the overall network utility, or not having UE handovers. Similar to the AC application, the size of action space for the LB application controlling N cells within a cluster is N+1.

Rewards: A uniform reward function for the applications (e.g., the admission control xApp, the load balancing xApp) reflects the objective function utility supplemented with a reward shaping function for faster convergence of the algorithm. To facilitate faster convergence, an exponential function-based reward shaping is applied which yields higher rewards for actions that provide close to the optimal utility values. This amplifies the difference between values of the utility function. The discerning of difference between applications' actions allows acceleration of the stochastic gradient descent (SGD) algorithm within the RL algorithm.

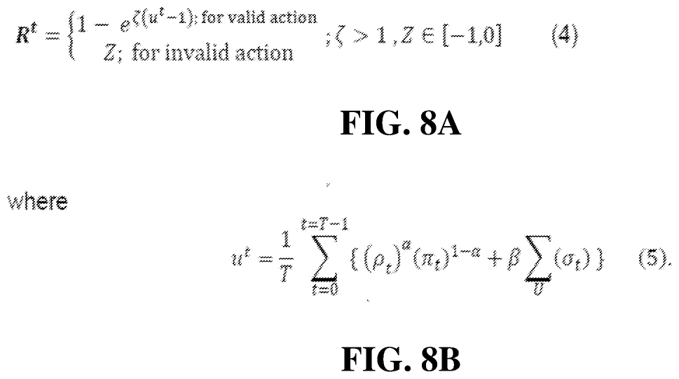

FIGS. 8A and 8B illustrate the long-term reward function (e.g., fourth equation (4) and fifth equation (5), respectively. As given in the fifth equation (5) of FIG. 8B, in the utility function u^{t}, a higher weighting cost is given to the penalty for user migration ratio within the utility function to avoid frequent handovers as they bring signaling loads which is an additional cost to the network. Depending on the value of β, only when the benefits of dynamic handover of UEs in terms of QoS improvement and energy efficiency overweigh the signaling cost; the LB application will recommend a handover policy. In most scenarios, a better balanced network in terms of PRB utilization not only improves the QoS performance but also improves the overall load dependent power consumption. Similarly, the AC application tends to achieve an optimal tradeoff between the network power consumption and the RRC rejection ratio, depending on the network operator managed tradeoff parameter a. When there is too much QoS degradation, at that point, it will be feasible for the cluster to reject the admission request in favor of better quality of service to the existing UEs. An invalid action in this use case may be the case when the applications suggest moving a UE to a cell that is fully loaded or does not provide coverage to the UE in its current location.

As discussed, provided herein is a method (and other embodiments) for energy efficiency aware load balancing and admission control in cellular networks using near real-time QoS KPIs feedback. Such load balancing and admission control results in an automated load balancing and admission control that does not impact the QoS of already served UEs instead of fixed service level agreement (SLA) thresholds that impose hard limits.

Constructing an optimization utility function to achieve a desired balance between energy efficiency and AC decisions are also provided herein. The utility function is dependent on cluster power consumption, RRC rejection rate, and percentage of UEs migrated to neighboring cells over a known time interval. The optimization function comes with UE QoS constraints on data rate and latency depending on the device types; along with cell level constraints on PRB utilization.

Also provided is use of a configurable priority between RRC connection rejections and cluster power consumption to control the algorithm's behavior. Moreover, another parameter is introduced to control the number of handovers to neighbor cells within the cluster.

The various embodiments also provide use of data-driven algorithms within disaggregated network architectures to automate the joint optimization of energy efficiency with load balancing and make relevant decisions on a per cell cluster basis.

As discussed herein, provided are systems, methods, and other embodiments for multi-cell admission control and load balancing within an O-RAN framework. A goal of the various embodiments is to maximize the number of UEs admitted within a cluster of cells with defined quality of service constraints while improving energy efficiency. Several embodiments have been provided to outline the ways in which the embodiments can be employed in the network design. Provided are AI and/or ML techniques that will be deployed and mapped to different network entities of the O-RAN framework within which they will be hosted along with the flow of data and requisite signaling for algorithmic learning, and policy executions. The disclosed embodiments provide a unique approach for simultaneous AI and/or ML applications (dApp, xApp, and rApp) deployment at O-RAN Control Unit (O-CU), near real-time RIC radio intelligent controller (near-RT RIC) and non-real-time radio intelligent controller (non-RT RIC) respectively, to enable fast decisions and cooperation between cells within a cell cluster. A data driven reinforcement learning approach for online learning and real-time policy execution can be employed. To improve the model performance, a combination of federated learning, transfer learning, and intent based reinforcement learning approaches can be utilized to yield better results and faster convergence.

Example, non-limiting Non-Real Time RAN Intelligent Controller (Non-RT RIC) functions include service and policy management, RAN analytics, and model training for the near-Real Time RICs. In this regard, the Non-RT-RIC enables non-real-time (e.g., a first range of time, such as >1 second) control of RAN elements and their resources through applications, e.g., specialized applications called rApps. Example, non-limiting Near-Real Time RAN Intelligent Controller (Near-RT RIC) functions enable near-real-time optimization and control and data monitoring of O-CU and O-DU nodes in near-RT timescales (e.g., a second range of time representing less time than the first time range, such as between 10 milliseconds and 1 second). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RAN Intelligent Controller (RT RIC) is designed to handle network functions at real time timescales (e.g., a third range of time representing less time than the first time range and the second time range, such as <10 milliseconds).

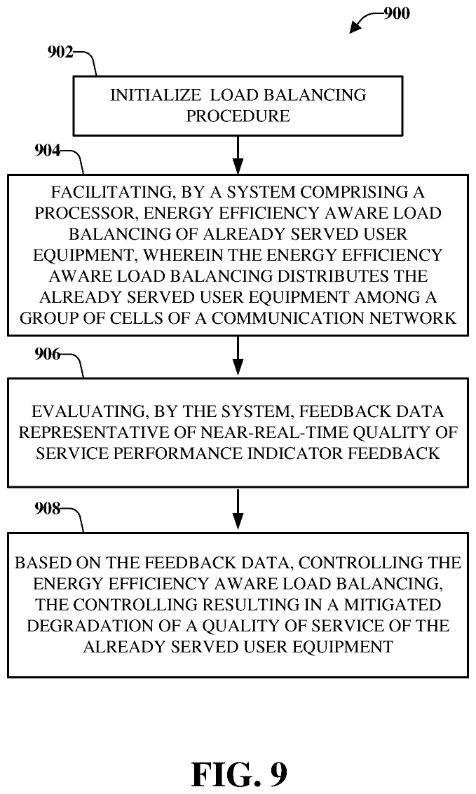

FIG. 9 illustrates a flow diagram of an example, non-limiting, computer-implemented method 900 that facilitates dynamic load balancing in advanced communication networks in accordance with one or more embodiments described herein. The computer-implemented method 900 and/or other methods discussed herein can be implemented by a system comprising a processor and a memory. In an example, the system can be implemented by a network equipment of a disaggregated network architecture. It is noted that the embodiment of FIG. 9 is discussed with respect to being deployed within an O-RAN framework, however, the disclosed embodiments are not limited to an O-RAN framework.

The computer-implemented method 900 can start at 902, with activation of a load balancing procedure. The load balancing procedure can be activated at defined time instances, periodically, at varying times, and so on. According to some implementations, the load balancing procedure can be activated based on a trigger event. For example, the trigger event can be based on the number of UEs being rejected (e.g., denial-of-service) during a defined time period being more than a threshold number of acceptable rejections. In another example, the trigger event can be based on identification of a network load imbalance and/or an indication that one or more cells are loaded more heavily than other cells.

At 904, energy efficiency aware load balancing of already served user equipment is facilitated. The energy efficiency aware load balancing can distribute the already served user equipment among a group of cells of a communication network. Upon or after one or more of the already served user equipment are distributed, at 906 the computer-implemented method 900 can evaluate feedback data representative of near-real-time quality of service performance indicator feedback. The feedback data can be near-real-time quality of service performance indicator feedback. Based on the feedback data, at 908 the computer-implemented method 900 can control the energy efficiency aware load balancing resulting in a mitigated degradation of a quality of service of the already served user equipment.

According to some implementations, the energy efficiency aware load balancing at 904 can include selecting a first cell of the group of cells for offloading of a first user equipment of the already served user equipment to a second cell of the group of cells. The group of cells are within control of a near-real-time-radio access network intelligent controller. Further, to this implementation, the energy efficiency aware load balancing can include, based on selection of the first cell, providing information indicative of offload instructions for the first user equipment to a centralized unit for validation.

Further to the above implementations, based on a completion of the connection transfer of the user equipment, the computer implemented method 900 can include determining an outcome of the connection transfer as a function of a change in a network utility. Further, the change in the network utility can be communicated for incorporation into a reinforcement learning model. According to some implementations, based on the validation of the offload instructions by the centralized unit, the computer-implemented method 900 can transfer the offload instructions to a scheduler for initiation of a connection transfer of the first user equipment.

According to some implementations, prior to selecting the first cell, the computer-implemented method 900 obtains average data usage from the cells. Further to this implementations, selecting the first cell is based on the average data usage and a defined policy. For example, the defined policy can be based on a function of cell loads, PRB utilization, and load states of neighbor cells.

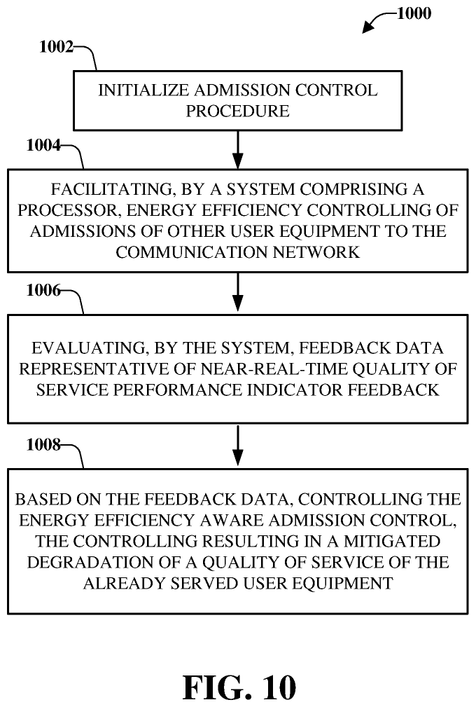

FIG. 10 illustrates a flow diagram of an example, non-limiting, computer-implemented method 1000 that facilitates energy aware admission control in advanced communication networks in accordance with one or more embodiments described herein. The computer-implemented method 1000 and/or other methods discussed herein can be implemented by a system comprising a processor and a memory. In an example, the system can be implemented by a network equipment of a disaggregated network architecture. It is noted that the embodiment of FIG. 1000 is discussed with respect to being deployed within an O-RAN framework, however, the disclosed embodiments are not limited to an O-RAN framework.

It is noted that, according to the disclosed aspects, the computer-implemented method 900 of FIG. 9 and the computer-implemented method 1000 of FIG. 10 can be performed at about a same time or at different times. Accordingly, the load balancing procedure and the admission control procedure can be activated (and executed) in parallel (e.g., at a same time, at substantially a same time, concurrently) or at different times. For example, one procedure can be activated and, at any point during its execution, the other procedure is activated. In another example, one procedure can be fully executed (or almost fully executed) and then the other procedure can be implemented (e.g., activated).

The computer-implemented method 1000 starts at 1002 with activation of an admission control procedure. The activation can be based on receipt of one or more requests, from one or more user equipment, to connect to the network.

At 1004, energy efficient control of admissions of other user equipment to the communication network is facilitated. Control of admissions can facilitate energy efficiency while retaining a defined quality of service for existing user equipment and providing the defined quality of service for the newly admitted user equipment.

Upon or after one or more user equipment are admitted (or not admitted) to the network, at 1006 the computer-implemented method 1000 can evaluate feedback data representative of near-real-time quality of service performance indicator feedback. The feedback data can be near-real-time quality of service performance indicator feedback. Based on the feedback data, at 1008 the computer-implemented method 1000 can control the energy efficiency aware admission control resulting in a mitigated degradation of a quality of service of the already served user equipment.

According to an implementation, controlling the energy efficiency aware admission control resulting in the mitigated degradation of the quality of service of the already served user equipment can include the controlling resulting in minimized degradation of the quality of service of the already served user equipment. Further to these implementations, the controlling of the admissions of other user equipment can include, based on receipt of a connection request from a first user equipment of the other user equipment, activating an admission control procedure. Further, based on a result of the admission control procedure and based on acceptance of an admission policy and a utility function, the computer-implemented method 100 can include selectively admitting the first user equipment to the group of cells. Further to these implementations, based on completion of an admission of the first user equipment, cell level data can be communicated (e.g., fed back) for incorporation into a reinforcement learning model.

In some implementations, activating the admission control procedure can include recommending, to a control unit (CU), a policy for admission of the second user equipment. Based on acceptance of the policy by the CU and based on a determination that the second user equipment is to be admitted in a same radio unit (RU) that received the connection request from the second user equipment, an acceptance acknowledgment can be sent to the second user equipment. Further, setup of the second user equipment can be completed with a selected cell of the cells.

In some implementations, activating the admission control procedure can include recommending, to a control unit (CU), a policy for admission of the second user equipment. Based on acceptance of the policy by the CU and based on a determination that the second user equipment is to be admitted in a different cell than the cell that received the connection request from the second user equipment, redirect information is sent to the second user equipment. Further, setup of the second user equipment is completed with the different cell. These implementations can also include, based on completion of the admission of the second user equipment at the different cell, communicating cell level data to a reinforcement learning model.

Methods that can be implemented in accordance with the disclosed subject matter will be better appreciated with reference to the flow charts provided herein. While, for purposes of simplicity of explanation, the methods are shown and described as a series of flows and/or blocks, it is to be understood and appreciated that the disclosed aspects are not limited by the number or order of flows and/or blocks, as some flows and/or blocks can occur in different orders and/or at substantially the same time with other blocks from what is depicted and described herein. Moreover, not all illustrated flows and/or blocks are required to implement the disclosed methods. It is to be appreciated that the functionality associated with the flows and/or blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

Aspects of systems, devices, apparatuses, and/or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the system can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise the system can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As used herein, the term “storage device,” “first storage device,” “second storage device,” “storage cluster nodes,” “storage system,” and the like (e.g., node device), can include, for example, private or public cloud computing systems for storing data as well as systems for storing data comprising virtual infrastructure and those not comprising virtual infrastructure. The term “I/O request” (or simply “I/O”) can refer to a request to read and/or write data.

The term “cloud” as used herein can refer to a cluster of nodes (e.g., set of network servers), for example, within an object storage system, which are communicatively and/or operatively coupled to one another, and that host a set of applications utilized for servicing user requests. In general, the cloud computing resources can communicate with user devices via most any wired and/or wireless communication network to provide access to services that are based in the cloud and not stored locally (e.g., on the user device). A typical cloud-computing environment can include multiple layers, aggregated together, that interact with one another to provide resources for end-users.

Further, the term “storage device” can refer to any Non-Volatile Memory (NVM) device, including Hard Disk Drives (HDDs), flash devices (e.g., NAND flash devices), and next generation NVM devices, any of which can be accessed locally and/or remotely (e.g., via a Storage Attached Network (SAN)). In some embodiments, the term “storage device” can also refer to a storage array comprising one or more storage devices. In various embodiments, the term “object” refers to an arbitrary-sized collection of user data that can be stored across one or more storage devices and accessed using I/O requests.

Further, a storage cluster can include one or more storage devices. For example, a storage system can include one or more clients in communication with a storage cluster via a network. The network can include various types of communication networks or combinations thereof including, but not limited to, networks using protocols such as Ethernet, Internet Small Computer System Interface (iSCSI), Fibre Channel (FC), and/or wireless protocols. The clients can include user applications, application servers, data management tools, and/or testing systems.

As utilized herein an “entity,” “client,” “user,” and/or “application” can refer to any system or person that can send I/O requests to a storage system. For example, an entity, can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

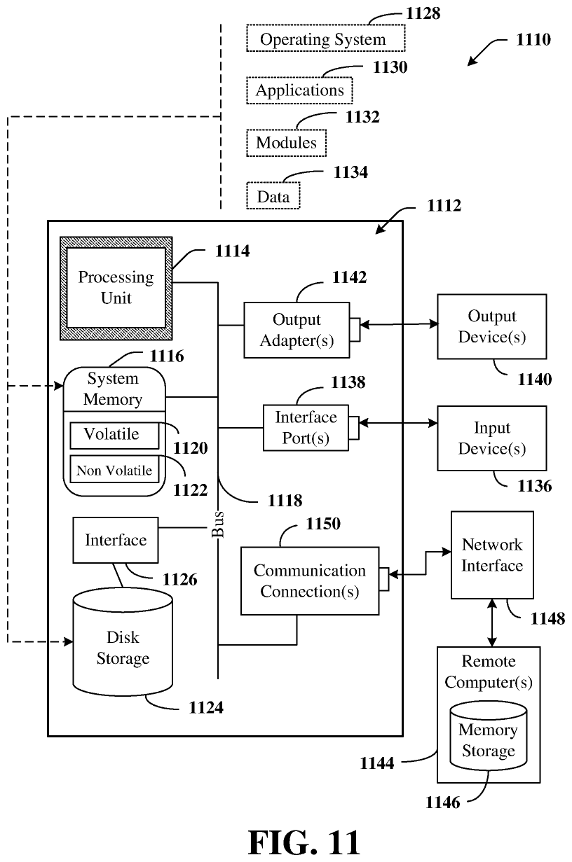

In order to provide a context for the various aspects of the disclosed subject matter, FIG. 11 as well as the following discussion are intended to provide a brief, general description of a suitable environment in which the various aspects of the disclosed subject matter can be implemented.

With reference to FIG. 11, an example environment 1110 for implementing various aspects of the aforementioned subject matter comprises a computer 1112. The computer 1112 comprises a processing unit 1114, a system memory 1116, and a system bus 1118. The system bus 1118 couples system components including, but not limited to, the system memory 1116 to the processing unit 1114. The processing unit 1114 can be any of various available processors. Multi-core microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 comprises volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can comprise read only memory (ROM), programmable ROM (PROM), electrically programmable ROM (EPROM), electrically erasable PROM (EEPROM), or flash memory.

Volatile memory 1120 comprises random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also comprises removable/non-removable, volatile/non-volatile computer storage media. FIG. 11 illustrates, for example a disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software comprises an operating system 1128. Operating system 1128, which can be stored on disk storage 1124, acts to control and allocate resources of the computer 1112. System applications 1130 take advantage of the management of resources by operating system 1128 through program modules 1132 and program data 1134 stored either in system memory 1116 or on disk storage 1124. It is to be appreciated that one or more embodiments of the subject disclosure can be implemented with various operating systems or combinations of operating systems.

A user enters commands or information into the computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 comprise, for example, a serial port, a parallel port, a game port, and a universal serial bus (USB). Output device(s) 1140 use some of the same type of ports as input device(s) 1136. Thus, for example, a USB port can be used to provide input to computer 1112, and to output information from computer 1112 to an output device 1140. Output adapters 1142 are provided to illustrate that there are some output devices 1140 like monitors, speakers, and printers, among other output devices 1140, which require special adapters. The output adapters 1142 comprise, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically comprises many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies comprise Fiber Distributed Data Interface (FDDI), Copper Distributed Data Interface (CDDI), Ethernet/IEEE 802.3, Token Ring/IEEE 802.5, and the like. WAN technologies comprise, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the system bus 1118. While communication connection 1150 is shown for illustrative clarity inside computer 1112, it can also be external to computer 1112. The hardware/software necessary for connection to the network interface 1148 comprises, for exemplary purposes only, internal and external technologies such as, modems including regular telephone grade modems, cable modems and DSL modems, ISDN adapters, and Ethernet cards.

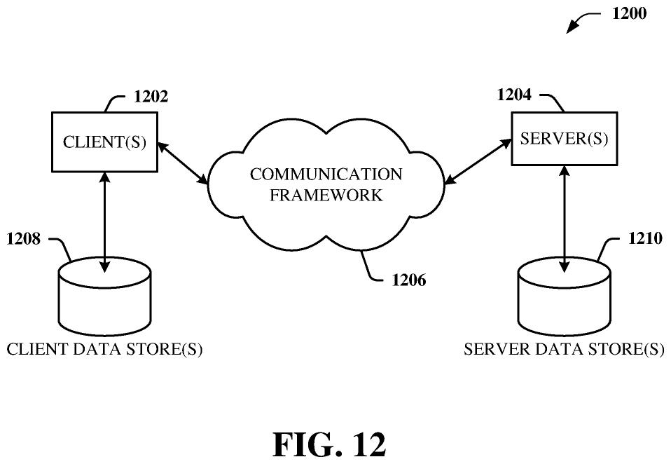

FIG. 12 is a schematic block diagram of a sample computing environment 1200 with which the disclosed subject matter can interact. The sample computing environment 1200 includes one or more client(s) 1202. The client(s) 1202 can be hardware and/or software (e.g., threads, processes, computing devices). The sample computing environment 1200 also includes one or more server(s) 1204. The server(s) 1204 can also be hardware and/or software (e.g., threads, processes, computing devices). The servers 1204 can house threads to perform transformations by employing one or more embodiments as described herein, for example. One possible communication between a client 1202 and servers 1204 can be in the form of a data packet adapted to be transmitted between two or more computer processes. The sample computing environment 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” “manager,” and the like are intended to refer to, or comprise, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. Yet another example, a component can be an apparatus that provides specific functionality through electronic components without mechanical parts, the electronic components can comprise a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable storage media can comprise, but are not limited to, radon access memory (RAM), read only memory (ROM), electrically erasable programmable read only memory (EEPROM), flash memory or other memory technology, solid state drive (SSD) or other solid-state storage technology, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments.

Disclosed embodiments and/or aspects should neither be presumed to be exclusive of other disclosed embodiments and/or aspects, nor should a device and/or structure be presumed to be exclusive to its depicted element in an example embodiment or embodiments of this disclosure, unless where clear from context to the contrary. The scope of the disclosure is generally intended to encompass modifications of depicted embodiments with additions from other depicted embodiments, where suitable, interoperability among or between depicted embodiments, where suitable, as well as addition of a component(s) from one embodiment(s) within another or subtraction of a component(s) from any depicted embodiment, where suitable, aggregation of elements (or embodiments) into a single device achieving aggregate functionality, where suitable, or distribution of functionality of a single device into multiple device, where suitable. In addition, incorporation, combination or modification of devices or elements (e.g., components) depicted herein or modified as stated above with devices, structures, or subsets thereof not explicitly depicted herein but known in the art or made evident to one with ordinary skill in the art through the context disclosed herein are also considered within the scope of the present disclosure.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding FIGS., where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a system comprising a processor, energy efficiency aware load balancing of already served user equipment, wherein the energy efficiency aware load balancing distributes the already served user equipment among a group of cells of a communication network; and
facilitating, by the system, controlling of admissions of other user equipment to the communication network, wherein the facilitating the energy efficiency aware load balancing and the facilitating the controlling of the admissions comprise:
evaluating feedback data representative of near-real-time quality of service performance indicator feedback; and
based on the feedback data, controlling the energy efficiency aware load balancing and the admission control, the controlling resulting in a mitigated degradation of a quality of service of the already served user equipment.

2. The method of claim 1, wherein the facilitating the energy efficiency aware load balancing comprises:
selecting a first cell of the group of cells for offloading of a first user equipment of the already served user equipment to a second cell of the group of cells, wherein the group of cells is within control of a near-real-time-radio access network intelligent controller; and
based on selection of the first cell, providing information indicative of offload instructions for the first user equipment to a centralized unit for validation.

3. The method of claim 2, further comprising:
based on a completion of the connection transfer of the user equipment, determining, by the system, an outcome of the connection transfer as a function of a change in a network utility; and
communicating, by the system, the change in the network utility for incorporation into a reinforcement learning model.

4. The method of claim 1, wherein the controlling resulting in the mitigated degradation of the quality of service of the already served user equipment comprises the controlling resulting in minimized degradation of the quality of service of the already served user equipment, and wherein the facilitating the controlling of the admissions of other user equipment comprises:
based on receipt of a connection request from a first user equipment of the other user equipment, activating an admission control procedure; and
based on a result of the admission control procedure and based on acceptance of an admission policy and a utility function, selectively admitting the first user equipment to the group of cells.

5. The method of claim 4, further comprising:
based on completion of an admission of the first user equipment, communicating, by the system, cell level data for incorporation into a reinforcement learning model.

6. The method of claim 1, wherein the communication network is deployed as a disaggregated architecture that comprises central units, distributed units, and a near-real-time-radio access network intelligent controller.

7. The method of claim 1, wherein the group of cells is configured to operate according to a new radio network communication protocol.

8. A system, comprising:
a processor; and
a memory that stores executable instructions that, when executed by the processor, facilitate performance of operations, comprising:
based on activation of a load balancing procedure,
selecting a first cell of cells for offloading of a first user equipment to a second cell of the cells, wherein the cells are within control of a near-real-time-radio access network intelligent controller; and
based on selection of the first cell, providing information indicative of offload instructions for the first user equipment to a centralized unit for validation; and
based on receipt of a connection request from a second user equipment:
activating an admission control procedure; and
based on a result of the admission control procedure, selectively admitting the second user equipment to the cells based on acceptance of an admission policy and a utility function.

9. The system of claim 8, wherein the operations further comprise:
based on a completion of the connection transfer of the second user equipment, determining an outcome of the connection transfer as a function of a change in a network utility; and
communicating the change in the network utility to a reinforcement learning model.

10. The system of claim 9, wherein the operations further comprise:
based on the validation of the offload instructions by the centralized unit, transferring the offload instructions to a scheduler for initiation of a connection transfer of the first user equipment.

11. The system of claim 8, wherein the operations further comprise:
prior to the selecting of the first cell, obtaining average data usage from the cells, wherein the selecting is based on the average data usage and a defined policy.

12. The system of claim 11, wherein the defined policy is based on a function of cell loads, PRB utilization, and load states of neighbor cells.

13. The system of claim 8, wherein the load balancing procedure is activated based on a cell within a cluster being determined to satisfy a utilization threshold.

14. The system of claim 8, wherein the activating the admission control procedure comprises:
recommending, to a control unit (CU), a policy for admission of the second user equipment;
based on acceptance of the policy by the CU and based on a determination that the second user equipment is to be admitted in a same radio unit (RU) that received the connection request from the second user equipment, sending an acceptance acknowledgment to the second user equipment; and
completing setup of the second user equipment with a selected cell of the cells.

15. The system of claim 8, wherein the activating the admission control procedure comprises:
recommending, to a control unit (CU), a policy for admission of the second user equipment;
based on acceptance of the policy by the CU and based on a determination that the second user equipment is to be admitted in a different cell than the cell that received the connection request from the second user equipment, sending redirect information to the second user equipment; and
completing setup of the second user equipment with the different cell.

16. The system of claim 15, wherein the operations further comprise:
based on completion of the admission of the second user equipment at the different cell, communicating cell level data to a reinforcement learning model.

17. The system of claim 11, wherein the system is deployed in a disaggregated architecture of network equipment.

18. A non-transitory machine-readable medium, comprising executable instructions that, when executed by a processor of network equipment, facilitate performance of operations, comprising:
performing, by a system comprising a processor, energy efficiency aware load balancing with respect to already served user equipment, wherein the energy efficiency aware load balancing distributes the already served user equipment among a plurality of cells of a communication network; and
controlling, by the system, admissions of other user equipment to the communication network, wherein the energy efficiency aware load balancing and the controlling of the admissions comprises:
evaluating near-real-time quality of service performance indicator feedback; and
based on the near-real-time quality of service performance indicator feedback, controlling the energy efficiency aware load balancing and the admissions to result in a reduced degradation of a quality of service of the already served user equipment.

19. The non-transitory machine-readable medium of claim 18, wherein the energy efficiency aware load balancing comprises:
selecting a first cell of the plurality of cells to use to offload a first user equipment of the already served user equipment to a second cell of the plurality of cells, wherein the plurality of cells is within control of a near-real-time-radio access network intelligent controller; and
based on selection of the first cell, providing information indicative of offload instructions for the first user equipment to a centralized unit for validation.

20. The non-transitory machine-readable medium of claim 18, wherein the controlling of the admissions of other user equipment comprises:
based on receipt of a connection request from a first user equipment of the other user equipment, activating an admission control procedure; and
based on a result of the admission control procedure, selectively admitting the first user equipment to the plurality of cells based on acceptance of an admission policy and a utility function.
